(19) United States
(12) Patent Application Publication
(10) Pub. No.: US 2022/0412274 A1
(43) Pub. Date: Dec. 29, 2022

(54) METHOD FOR CONTROLLING ENGINE BRAKING OF AN INTERNAL COMBUSTION ENGINE

(71) Applicant: VOLVO TRUCK CORPORATION, Göteborg (SE)

(72) Inventors: Fredrik HOLST, Göteborg (SE); Per BRODEN, Västra Frölunda (SE)

(21) Appl. No.: 17/778,050

(22) PCT Filed: Nov. 20, 2019
(86) PCT No.: PCT/EP2019/081940

§ 371 Date: May 19, 2022

(51) Int. Cl. F02D 13/04; F02D 13/02; F02D 41/14; F02D 41/30

(52) U.S. Cl. CPC F02D 13/04; F02D 13/0207; F02D 41/1445; F02D 41/1486; F02D 41/30

(57) ABSTRACT

The invention relates to controlling engine braking of an internal combustion engine wherein the method includes setting the engine in an engine braking mode comprising i) interrupting fuel supply to a first cylinder, ii) restricting the flow of gas through an exhaust duct using an adjustable flow restricting member, and iii) controlling inlet and exhaust valves of the first cylinder in a compression-release mode comprising controlling the valves to compress gas in a combustion chamber when the piston moves towards the top dead center position (TDC) and release compressed gas into the exhaust duct when the piston is near the TDC. The method includes, prior to ii and iii: reducing a total gas mass flow rate through the engine by controlling, for at least one of valve, reducing a valve lift and/or adjusting a timing of a valve opening or closing so as to reduce the gas mass flow rate through the cylinder.

### TECHNICAL FIELD

The invention relates to a method for controlling engine braking of an internal combustion engine. In particular the invention relates to reducing noise from such engine braking.

The invention can typically be applied in heavy-duty vehicles, such as trucks, buses and construction equipment. Although the invention will be described with respect to a truck it is not restricted to this particular vehicle.

### BACKGROUND

Heavy vehicles, such as trucks and buses, are commonly arranged so that an engine thereof can be set in an engine braking mode where the engine is used to retard the speed of the vehicle. Various ways of arranging and controlling inlet and exhaust valves to achieve this effect have been proposed. An effective method of achieving such engine braking in an engine cylinder includes the steps of i) interrupting fuel supply to the cylinder, ii) restricting a gas flow through an exhaust duct connected to the cylinder so as to generate a backpressure in the exhaust duct, and iii) controlling the inlet and exhaust valves in a compression-release mode where the valves are controlled to compress gas in the cylinder combustion chamber when the piston moves towards the top dead center position (TDC) and release the compressed gas into the exhaust duct when the piston is near the TDC. This slows down the linear movement of the piston and thus the rotational speed of a crankshaft connected to the piston, which in turn retards the speed of the vehicle.

Examples of arrangements and methods for the above type of engine braking are disclosed in U.S. Pat. No. 5,146,890 and WO2017/129262.

A disadvantageous effect of the above compression-release mode of the valves is that loud noise pulses commonly are produced when the compressed gas is released as pressure peaks in the exhaust system. The noise may be so loud that this kind of effective engine braking may not be allowed due to noise regulation requirements in certain areas. There is thus a need for an effective engine braking method and arrangement that produces less noise.

### SUMMARY

An object of the invention is to provide a method for controlling engine braking of an internal combustion engine, which method enables effective braking but that generates less noise than existing methods. This object is achieved by a method according to claim 1. Further aspects of the invention relate to e.g. an internal combustion engine configured to be operated according to said method.

The invention relates to a method for controlling engine braking of an internal combustion engine, wherein the internal combustion engine comprises: at least a first cylinder provided with an inlet valve and an exhaust valve for controlling communication between a combustion chamber in the cylinder and an inlet duct and an exhaust duct, respectively; a piston configured to move in a reciprocating manner in said first cylinder between a top dead center position (TDC) close to the inlet and exhaust valves and a bottom dead center position (BDC) away from said valves; and a valve actuation arrangement configured to control opening and closing of the inlet and exhaust valves, wherein the method comprises a step of setting the internal combustion engine in an engine braking mode comprising controlling the inlet and exhaust valves in a compression-release mode comprising controlling the valves so as to compress gas in the combustion chamber when the piston moves towards the TDC and release the compressed gas into the exhaust duct when the piston is near the TDC.

The method further comprises the step of, prior to the step of controlling the inlet and exhaust valves in the compression-release mode, reducing a total mass flow rate of gas through the internal combustion engine by controlling the inlet and exhaust valves in a mass flow reduction mode comprising, for at least one of the inlet valve and the exhaust valve of the first cylinder, reducing a valve lift and/or adjusting a timing of a valve opening or closing so as to reduce the mass flow rate of gas through the first cylinder compared to a nominal mass flow rate.

In embodiments of the invention the internal combustion engine may comprise a fuel supply system for supplying fuel to the first cylinder and/or an adjustable flow restricting member arranged in the exhaust duct, wherein the adjustable flow restricting member is configured to be controlled to restrict a flow of gas through the exhaust duct so as to allow building up of a backpressure during engine braking. In such embodiments the step of setting the internal combustion engine in the engine braking mode may comprise a step of interrupting fuel supply to the first cylinder and/or a step of restricting the flow of gas through the exhaust duct using the adjustable flow restricting member. Interrupting fuel supply during engine braking is a normal measure to avoid wasting fuel (but fuel can be supplied during engine braking). Restricting the exhaust gas flow to build up a backpressure is normally done to increase braking efficiency (but is not necessary).

The pressure pulses generated when the compressed gas is released to the exhaust duct may give rise to a considerable noise due to resonances and coupled oscillations etc. generated by a sudden transition from normal engine operation mode to engine braking mode with a full mass flow of gas through the engine. By controlling the valves to let through a smaller flow of gas/air through the first cylinder and thus reducing the mass flow of gas through the engine before applying the compression brake, the transition from operation mode to braking mode will be less sudden and the power of the pressure pulses can be decreased leading to a significant reduction of the noise. The engine may of course be provided with several cylinders and if so the reduced valve lift and/or adjusted timing of valve opening or closing may be applied to several of the engine's cylinders. With several cylinders it is also possible to use a variant where at least one of the intake and exhaust valves is kept completely closed on one or some of the cylinders, i.e. the valve lift is reduced to zero and/or the timing is adjusted so that the valve is not opened at all.

There are various ways of controlling the valves to reduce the mass flow through the first cylinder and through the entire engine, in particular for a cam-less engine provided with a fully variable valve actuation arrangement. In addition, different cylinders may be controlled in different ways and reduced valve lift, i.e. one or both valves are lifted/opened to a smaller degree than during normal operation of the engine, can be combined with adjusted timing of valve opening or closing. How to adjust timing of valve opening and closing to reduce mass flow rate depends on how the valves are controlled during normal operation of the engine. For instance, if the intake valve normally is closed before the piston reaches its BDC, the mass flow rate will decrease if the intake valve is closed somewhat earlier. In another example the intake valve may normally be closed after the piston has passed its BDC (such as with late Miller type timing), and in such a case the mass flow rate will decrease if the intake valve is closed somewhat later (or significantly earlier with a sufficient margin before the piston reaches BDC). Moreover, a particular valve controlling sequence during mass flow rate reduction may be carried out every second piston stroke (two-stroke) or every fourth piston stroke (four-stroke). Also the point of time for opening the inlet valve can be adjusted, as well as the opening and closing timing of the exhaust valve. One form of adjusted timing is to not open the valve at all, which then becomes the same as zero valve lift.

When the total mass flow rate has been reduced to a sufficient level for the particular application and situation, one may perform the step of controlling the inlet and exhaust valves so as to generate the compression release engine break, and preferably also the step of restricting the flow through the exhaust duct using the adjustable flow restricting member, and thus go into the engine braking mode. These two steps may be performed simultaneously and to achieve a smooth transition of modes it is preferred to successively/stepwise build up the backpressure in the exhaust duct and successively/stepwise switch to valve timing and/or valve lifts to be used in the engine braking mode. The step of restricting the flow through the exhaust duct may be initiated before the total mass flow rate has been reduced to the sufficient level, at least if the flow restriction is moderate in the beginning.

That the mass flow rate of gas through the first cylinder is reduced compared to a nominal mass flow rate means that it is reduced compared to the mass flow rate that would have been the result without said reduction in valve lift and/or adjustment of timing of valve opening or closing. It thus means that the mass flow rate is reduced compared to what would be the case when setting the engine in engine braking mode without this particular control of the inlet and/or exhaust valve. It might be that the gas mass flow rate becomes lower when activating breaking mode than before setting the engine in this mode irrespective of any particular controlling of the valves since releasing an acceleration pedal or similar might also lead to at least some reduction of the mass flow rate. However, such a pedal-induced “automatic” reduction of mass flow rate is often not sufficient with regard to noise generation and the particular valve control of the present invention leads to an additional reduction of the mass flow rate of gas through the engine.

As mentioned above, the particular control of the inlet and/or the exhaust valves for reducing the mass flow rate may be carried out in 2-stroke or 4-stroke mode, i.e. during each revolution of a crankshaft connected to the piston or during every second revolution of the crankshaft. However, deviations from regular 2- or 4-stroke sequences are possible, at least for a cam-less engine provided with a fully variable valve actuation arrangement.

Also the controlling of the inlet and exhaust valves in the compression-release mode may be carried out in 2-stroke or 4-stroke mode.

In an embodiment the step of reducing the total mass flow rate of gas through the internal combustion engine comprises: keeping at least one of the inlet and exhaust valves closed during at least one revolution of a crankshaft connected to the piston. As mentioned above, this is a special case. Various other options are possible.

In an embodiment the method comprises the step of: determining whether the mass flow rate through the internal combustion engine has been reduced to a mass flow rate threshold indicative of a sufficient level for the particular application and situation. Such a threshold may depend on the type of engine etc. but also on engine speed, vehicle velocity, etc. However, a particular mass flow rate threshold is not required as the step of reducing the total mass flow rate may be interrupted using another trigger, such as a pre-set time period, that may depend on the operation conditions. When to interrupt or phase out the step of reducing the total mass flow rate may also depend on how the ramping in of the valve compression-release mode is carried out.

In an embodiment the method comprises the step of: gradually restricting the flow through the exhaust duct using the adjustable flow restricting member so as to gradually build up a backpressure in the exhaust duct. A gradual (e.g. stepwise) increase of backpressure reduces the risk of producing noise or other disturbing vibrations.

In an embodiment the method comprises the step of: controlling the inlet and exhaust valves so as to change operation mode from the mass flow reduction mode to the compression-release mode. This change may be done more or less gradually depending on the conditions, such as need for braking power, and it may be done while gradually building up the backpressure.

In an embodiment the valve actuation arrangement is a fully variable valve actuation arrangement. This means that the valves are not controlled by cams of a camshaft but are configured to be controllable by electronic, pneumatic and/or hydraulic means.

The invention also concerns an internal combustion engine comprising at least a first cylinder provided with an inlet valve and an exhaust valve for controlling communication between a combustion chamber in the cylinder and an inlet duct and an exhaust duct, respectively; a piston configured to move in a reciprocating manner in said first cylinder between a top dead center position (TDC) close to the inlet and exhaust valves and a bottom dead center position (BDC) away from said valves; a valve actuation arrangement configured to control opening and closing of the inlet and exhaust valves; an adjustable flow restricting member arranged in the exhaust duct and being configured to be controlled to restrict a flow of gas through the exhaust duct so as to allow building up of a backpressure during engine braking; a fuel supply system for supplying fuel to the first cylinder, and a control circuitry configured to control operation of the internal combustion engine, wherein the internal combustion engine is configured to be set in an engine braking mode comprising i) interrupting fuel supply to the first cylinder, ii) restricting the flow of gas through the exhaust duct using the adjustable flow restricting member, and iii) controlling the inlet and exhaust valves in a compression-release mode comprising controlling the valves so as to compress gas in the combustion chamber when the piston moves towards the TDC and release the compressed gas into the exhaust duct when the piston is near the TDC, wherein the control circuitry is configured to carry out the steps of the above method.

If setting the engine in engine braking mode does not include interrupting fuel supply, as mentioned above, it is not strictly necessary that the engine is provided with a fuel supply system for supplying fuel to the first cylinder (which, however, is likely to be required for operating the first cylinder in a normal operation mode). Similarly, if setting the engine in engine braking mode does not include restricting the flow of gas through the exhaust duct using the adjustable flow restricting member, it is not necessary that the engine is provided with an adjustable flow restricting member.

In an embodiment of the internal combustion engine, the valve actuation arrangement is a fully variable valve actuation arrangement.

The adjustable flow restriction member may in principal be located anywhere in the exhaust duct. For instance, if the engine is provided with a turbocharging arrangement comprising a compressor for compressing intake air and a turbine that drives the compressor and that is driven by the exhaust gas flow, the adjustable flow restriction member may be located downstream or upstream the turbine. If a single flow restriction member is used it is preferably arranged to restrict the flow through all cylinders of the engine. More than one flow restriction member may be used where there are separate exhaust ducts (from individual cylinders or groups of cylinders). Various special arrangements are also possible, such as when a first adjustable flow restricting member is arranged to restrict the flow from the first cylinder and a second adjustable flow restricting member is arranged to restrict the flow from remaining or all cylinders.

The invention further relates to:

a computer program product comprising program code means for performing the steps of the above method when said program is run on a computer;

a computer readable medium carrying a computer program comprising program code means for performing the steps of the above method when said program product is run on a computer; and

a control unit for controlling engine braking of an internal combustion engine, the control unit being configured to perform the steps of the above method.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 shows a vehicle provided with an internal combustion engine configured to be operated according to this disclosure.

FIG. 2 shows a schematic view of a cylinder, piston, etc. of the internal combustion engine according to FIG. 1.

FIG. 3 shows a schematic view of the internal combustion engine according to FIG. 1.

FIG. 4 shows an example flow chart of a method according to this disclosure.

### DETAILED DESCRIPTION OF EXAMPLE EMBODIMENTS OF THE INVENTION

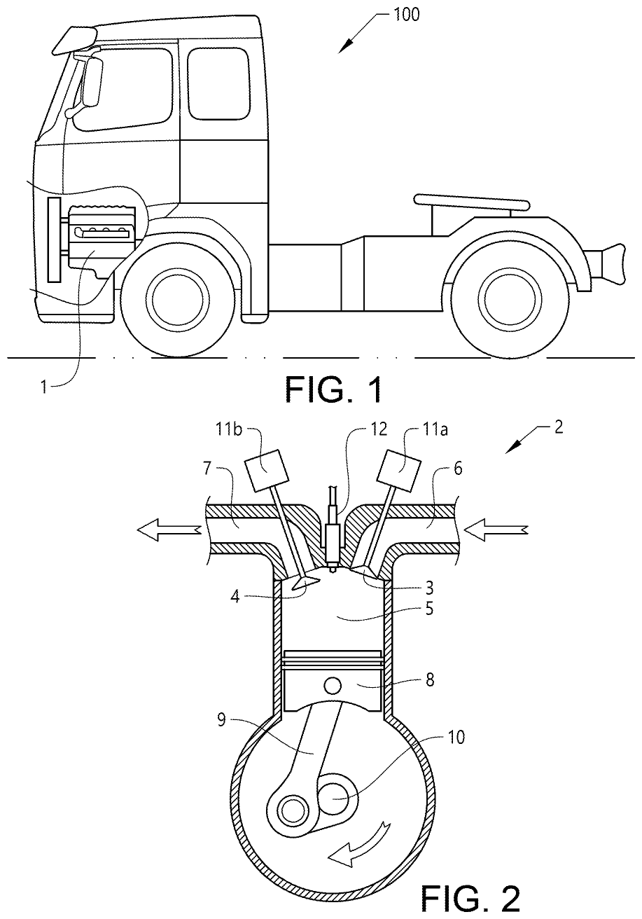

FIG. 1 shows a vehicle in the form of a truck 100 provided with an internal combustion engine 1 configured to be operated according to a method as described below.

FIG. 2 shows a schematic view of a first cylinder 2 forming part of the internal combustion engine according to FIG. 1. The first cylinder 2 is provided with an inlet valve 3 and an exhaust valve 4 for controlling communication between a combustion chamber 5 in the cylinder 2 and an inlet duct 6 and an exhaust duct 7, respectively. A piston 8 is connected via a connection rod 9 to a rotatable crankshaft 10 and is configured to move in a reciprocating manner in said first cylinder 2 between a top dead center position (TDC) close to the inlet and exhaust valves 3, 4 (i.e. an upper end position in FIG. 2) and a bottom dead center position (BDC) away from said valves 3, 4 (i.e. a lower end position in FIG. 2).

Further, the cylinder 2 is provided with a valve actuation arrangement 11a, 11b configured to control opening and closing of the inlet and exhaust valves 3, 4. In this example the valve actuation arrangement 11a, 11b is a fully variable valve actuation arrangement configured to be controllable by electronic means. That is, the engine 1 is in this case a so-called cam-less engine where timing and lifting of the valves is not activated by, nor dependent on, any camshaft but can instead be freely controlled by the fully variable valve actuation arrangement.

FIG. 2 also indicates that the cylinder 2 is provided with a fuel supply system 12 for supplying fuel, such as diesel, to the first cylinder 2.

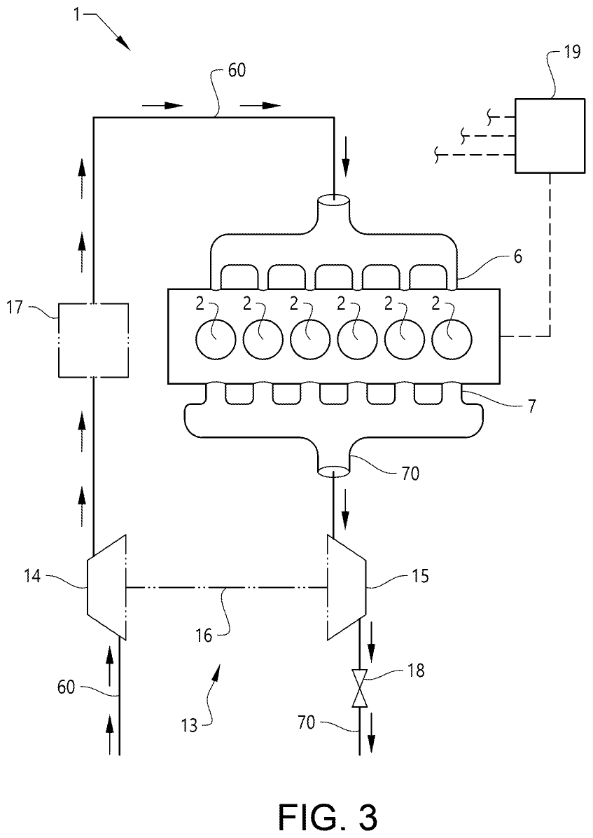

FIG. 3 shows a schematic view of the internal combustion engine 1 according to FIG. 1. In this example the engine 1 is provided with six identical cylinders 2 all being arranged as shown in FIG. 2. In FIG. 3 it has been indicated in dashed lines that the engine 1 may be provided with a turbocharging arrangement 13 comprising a turbocharger compressor 14 and a turbine 15 connected via shaft 16. Also an optional charge air cooler 17 is indicated in FIG. 3.

A main intake duct 60 guides intake air via the turbocharger compressor 14 and the cooler 17 towards the inlet duct 6 of each of the cylinders 2. Exhaust gas leaving the cylinders 2 via each of the corresponding exhaust ducts 7 is channelled via main exhaust duct 70 to the turbine 15 which drives the compressor 14. Downstream the turbine 15 the main exhaust duct 70 is in this example provided with an adjustable flow restricting member 18 configured to be controlled to restrict a flow of gas through the main exhaust duct 70, and thereby also the flow through each of the individual exhaust ducts 7, so as to allow building up of a backpressure during engine braking. The adjustable flow restricting member 18 may be a butterfly valve.

FIG. 3 also indicates that the engine 1 comprises a control circuitry 19 configured to control operation of the internal combustion engine 1, including e.g. controlling the fuel supply system 12, the inlet and exhaust valves 3, 4 (by controlling the valve actuation arrangement 11a, 11b) and the adjustable flow restricting member 18, so as to set the engine 1 in an engine braking mode. In line with conventional engines, the control circuitry 19 is configured to control also various other components of the engine 1 and to receive various input signals from sensors of various kinds.

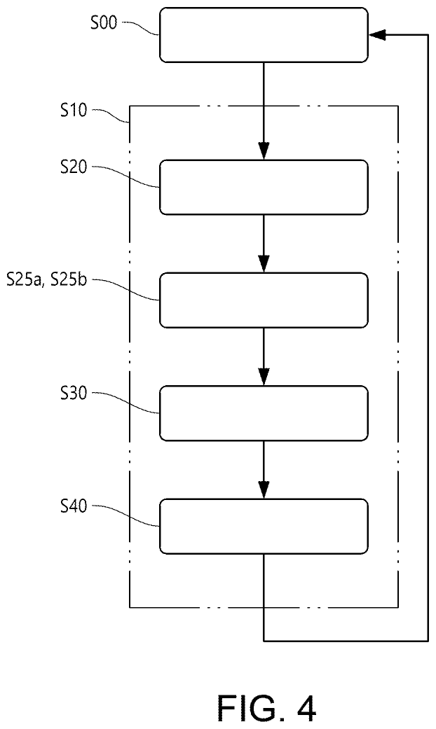

FIG. 4 shows an example flow chart of a method according to this disclosure:

Step S00 represents a normal engine operation mode, i.e. the engine 1 is not in a braking mode and the cylinders 2 are operated to combust fuel and generate a torque to the crankshaft 10 via piston 8 and connection rod 9.

Step S10 represents the entire step of setting the internal combustion engine 1 in the engine braking mode, which step in this example comprises the following sub-steps:
S20—interrupting fuel supply 12 to the first cylinder 2;
S25—reducing the total mass flow rate of gas through the internal combustion engine 1, i.e. through all the six cylinders 2, by controlling the inlet and exhaust valves 3, 4 in a mass flow reduction mode comprising, for at least one of the inlet valve 3 and the exhaust valve 4 of at least one of the cylinders 2,
   S25a—reducing a valve lift, and/or
   S25b—adjusting a timing of a valve opening or closing so as to reduce the mass flow rate of gas through that cylinder 2 compared to a nominal mass flow rate (which, as explained above, is the mass flow rate that would have been the result without step S25);
S30—restricting the flow of gas through the exhaust duct 7, 70 using the adjustable flow restricting member 18; and
S40—controlling the inlet and exhaust valves 3, 4 in a compression-release mode comprising controlling the valves 3, 4 so as to compress gas in the combustion chamber 5 when the piston 8 moves towards the TDC and release the compressed gas into the exhaust duct 7, 70 when the piston 8 is near the TDC.

Due to the reduction of mass flow rate achieved by step S25 the pressure pulses and accompanying noise generated in step S40 will be less powerful.

When engine braking is no longer desired the engine 1 can be re-set in its normal operation mode S00, for instance by pressing down an acceleration pedal of the vehicle.

As mentioned previously, there are many ways of controlling the valve lift and/or adjusting the timing of the valve opening or closing for the purpose of reducing the mass flow rate in step S25. Generally, a smaller amount of gas/air should be allowed to pass the cylinder than during normal valve lift and valve timing. In one example, only the inlet valve lift is reduced compared to normal operation of the engine. In another example the timing of only the opening of the inlet valve 3 is adjusted so that a smaller amount of gas/air enters the cylinder 2 compared to normal operation. In other examples only the lift or timing of the exhaust valve 4 is reduced or adjusted, respectively. Various combinations are also possible.

Since the engine 1 is provided with a plurality of cylinders 2, the step S25 may comprise the step of keeping at least one of the inlet and exhaust valves 3, 4 of at least one of the cylinders 2 closed during at least one revolution of the crankshaft. With at least one of the valves closed, no gas/air will pass through that/those particular cylinder(s), which reduces the total mass flow rate through the engine 1. The valve(s) may be kept closed during several revolutions of the crankshaft.

After some time, perhaps within some seconds, step S25 is interrupted and steps S30 and S40 are initiated (or continued if already started). It should be noted that the steps are not necessarily distinctly separated as indicated in FIG. 4. As an example, step S30 is preferably carried out gradually, i.e. by gradually/stepwise closing the adjustable flow restricting member 18 so as to gradually build up the backpressure in the exhaust duct 7, 70. Step 30 may start while step S25 is performed. Another example is that controlling the inlet and exhaust valves 3, 4 so as to change operation mode from the mass flow reduction mode (S25) to the compression-release mode (S40) also may be carried out in a gradual/stepwise manner which takes some time, and step S30 may be carried out while the change of valve control is carried out. In general it can be said that step S25 is carried out before step S40 and before the maximum backpressure has been built up in step S30.

The method may comprise the step of: determining, during step S25, whether the mass flow rate through the internal combustion engine 1 has been reduced to a mass flow rate threshold indicative of a sufficient level for the particular application and situation. When the threshold has been reached the change of valve operation mode may start. Alternatively, step S25 may be interrupted after a pre-set time period (i.e. the step of controlling the inlet and exhaust valves 3, 4 so as to change operation mode from the mass flow reduction mode (S25) to the compression-release mode (S40) may start after the pre-set time period).

It is to be understood that the present invention is not limited to the embodiments described above and illustrated in the drawings; rather, the skilled person will recognize that many changes and modifications may be made within the scope of the appended claims.

1. A method for controlling engine braking of an internal combustion engine,
wherein the internal combustion engine comprises:
at least a first cylinder provided with an inlet valve and an exhaust valve for controlling communication between a combustion chamber in the first cylinder and an inlet duct and an exhaust duct, respectively;
a piston configured to move in a reciprocating manner in said first cylinder between a top dead center position (TDC) close to the inlet valve and the exhaust valve and a bottom dead center position (BDC) away from said inlet valve and said exhaust valve; and
a valve actuation arrangement configured to control opening and closing of the inlet valve and the exhaust valve,
wherein the method comprises the steps of;
setting the internal combustion engine in an engine braking mode comprising controlling the inlet valve and the exhaust valve in a compression-release mode comprising controlling the inlet valve and the exhaust valve so as to compress gas in the combustion chamber when the piston moves towards the TDC and release the compressed gas into the exhaust duct when the piston is near the TDC; and
prior to the step of controlling the inlet valve and the exhaust valve in the compression-release mode, reducing a total mass flow rate of gas through the internal combustion engine by controlling the inlet valve and the exhaust valve in a mass flow reduction mode comprising, for at least one of the inlet valve and the exhaust valve of the first cylinder, reducing a valve lift and/or adjusting a timing of a valve opening or closing so as to reduce the mass flow rate of gas through the first cylinder compared to a nominal mass flow rate.

2. The method according to claim 1, wherein the internal combustion engine comprises a fuel supply system for supplying fuel to the first cylinder, and wherein the step of setting the internal combustion engine in the engine braking mode comprises a step of interrupting fuel supply to the first cylinder.

3. The method according to claim 1, wherein the internal combustion engine comprises an adjustable flow restricting member arranged in the exhaust duct, wherein the adjustable flow restricting member is configured to be controlled to restrict a flow of gas through the exhaust duct so as to allow building up of a backpressure during engine braking, and wherein the step of setting the internal combustion engine in the engine braking mode comprises restricting the flow of gas through the exhaust duct using the adjustable flow restricting member.

4. The method according to claim 1, wherein the step of reducing the total mass flow rate of gas through the internal combustion engine comprises:
keeping at least one of the inlet valve and the exhaust valve closed during at least one revolution of a crankshaft connected to the piston.

5. The method according to claim 1, wherein the method further comprises the step of:
determining whether the mass flow rate through the internal combustion engine has been reduced to a mass flow rate threshold indicative of a sufficient level for the particular application and situation.

6. The method according to claim 3, wherein the method further comprises the step of:
gradually restricting the flow through the exhaust duct using the adjustable flow restricting member so as to gradually build up a backpressure in the exhaust duct.

7. The method according to claim 1, wherein the method further comprises the step of:
controlling the inlet valve and the exhaust valve so as to change operation mode from the mass flow reduction mode to the compression-release mode.

8. The method according to claim 1, wherein the valve actuation arrangement is a fully variable valve actuation arrangement.

9. An internal combustion engine comprising
at least a first cylinder provided with an inlet valve and an exhaust valve for controlling communication between a combustion chamber in the cylinder and an inlet duct and an exhaust duct, respectively;
a piston configured to move in a reciprocating manner in said first cylinder between a top dead center position (TDC) close to the inlet valve and the exhaust valve and a bottom dead center position (BDC) away from said inlet valve and said exhaust valve;
a valve actuation arrangement configured to control opening and closing of the inlet valve and the exhaust valve;
an adjustable flow restricting member arranged in the exhaust duct and being configured to be controlled to restrict a flow of gas through the exhaust duct so as to allow building up of a backpressure during engine braking;
a fuel supply system for supplying fuel to the first cylinder, and
a control circuitry configured to control operation of the internal combustion engine,
wherein the internal combustion engine is configured to be set in an engine braking mode comprising i) interrupting fuel supply to the first cylinder, ii) restricting the flow of gas through the exhaust duct using the adjustable flow restricting member, and iii) controlling the inlet valve and the exhaust valve in a compression-release mode comprising controlling the inlet valve and the exhaust valve so as to compress gas in the combustion chamber when the piston moves towards the TDC and release the compressed gas into the exhaust duct when the piston is near the TDC,
wherein the control circuitry is configured to carry out the method steps of interrupting the fuel supply, restricting the flow of gas through the exhaust duct and controlling the inlet valve and the exhaust valve in the compression-release mode.

10. The internal combustion engine according to claim 9, wherein the valve actuation arrangement (is a fully variable valve actuation arrangement.

11. A computer program product comprising program code means for performing the steps of claim 1 when said program is run on a computer.

12. A computer readable medium carrying a computer program comprising program code means for performing the steps of claim 1 when said program product is run on a computer.

13. A control unit for controlling an internal combustion engine, the control unit being configured to perform the steps of the method according to claim 1.
